(19) United States
(12) Patent Application Publication
(10) Pub. No.: US 2010/0274667 A1
(43) Pub. Date: Oct. 28, 2010

(54) MULTIMEDIA ACCESS

(75) Inventors: Drew Lanham, Menlo Park, CA (US); Marsal Gavalda, Sandy Springs, GA (US); John Willcutts, Marietta, GA (US); Gordon Edwards, Stockbridge, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/429,218

(22) Filed: Apr. 24, 2009

(51) Int. Cl. G06F 17/30; G06Q 30/00; G10L 19/00; G06F 17/00

(52) U.S. Cl. 705/14.49; 715/230; 704/201; 707/E17.014; 707/E17.103; 707/E17.009; 715/205

(57) ABSTRACT

A computer-implemented method provides access to multimedia content, which include units of content that include audio components. Meta data for the units of content is formed to an association of key phrases detected in the audio components and the units. In some examples, forming the meta data includes determining a candidate set of key phrases associated with the unit of multimedia and searching for the presence of the candidate key phrases in the audio components. Forming the meta data then includes forming data representing the presence of key phrases in the audio components.

### BACKGROUND

This specification relates to providing access to multimedia.

The amount of multimedia content (e.g., combinations of one or more of audio, image, animation, video, etc.), for example, distributed over many different servers on the Internet, has been growing progressively over the past decade. In addition to media being hosted on servers associated with the providers of the content (e.g., on a web server associated with a television network), a number of web-based systems provide for users to upload video to a communal library. One such system is the YouTube system. In many cases, however, such content is often presented in a form that may not provide an easy means for search and access by potential users. One reason for the difficulty lies in the lack of adequate tagging and search approaches. For example, in a recording of a lengthy political speech, a user may not be able to quickly locate a topic most relevant to his interest. Even if the recording has been pre-processed, for example, to be available as individual segments, the user still may not be able to access the desired topic either because the audio does not have reliable tags that would direct the him to the corresponding segment, or because without proper search tools the user is not able to make use of the tags.

### SUMMARY

In one aspect, in general, a computer-implemented method provides access to multimedia content. Audio components associated with a set of units of multimedia content are accepted. Each unit of content includes one or more of the audio components. For each unit of the multimedia content, meta data associated with that unit is formed. This meta data for the units includes an association of key phrases detected in the audio components and the units. Forming the meta data includes determining a candidate set of key phrases associated with the unit of multimedia. Presence of the candidate key phrases is searched for in the audio components. Forming the meta data then includes forming data representing the presence of key phrases in the audio components.

Aspects may include one or more for the following.

The set of key phrases associated with the unit includes a universal set of key phrases selected independently of the unit.

The method further includes adding the units of multimedia content to a library of content.

The accepting of the audio components of a unit of content is at the time the unit is added to the library.

At least some of the forming of the meta data for the unit is performed at the time the unit is added to the library.

Determining a candidate set of key phrases associated with the unit of multimedia includes accepting the candidate key phrases in conjunction with receiving of the audio component.

The candidate key phrases are accepted from a party providing the unit of multimedia.

Determining a candidate set of key phrases associated with the unit of multimedia includes identifying text associated with the units of multimedia, and selecting key phrases according to the identified text.

Identifying the text associated with a unit of the multimedia includes accepting the text in conjunction with receiving of the audio component.

The text is accepted from a party providing the unit of multimedia.

Identifying the text associated with a unit of the multimedia includes identifying a text component that is linked to the unit of multimedia.

The text component is linked to the unit of multimedia via a hyperlink.

Identifying the text associated with a unit of the multimedia includes identifying text embedded in a video component of the unit of multimedia.

Determining a candidate set of key phrases associated with the unit of multimedia includes determining one or more classes associated with the unit and selecting key phrases associated with the determined one or more classes.

The classes include topics.

Determining the one or more classes associated with the unit is performed at the time that the unit is added to a library.

Selecting key phrases associated with the determined classes, searching for the presence of the selected key phrases, and updating the meta data according to the searching is repeated multiple times subsequent to determining the classes.

Determining the one or more classes associated with the unit includes accessing a data representation of a set of classes and relationships between the classes.

A first set of candidate classes from the representation is identified. For each candidate class in the first set, presence of the key phrases associated with said candidate class is searched for in the audio component of the unit of content. An association of the unit with the class is determined according to the determined presence of the key phrases in the audio component.

Determining the one or more classes associated with the unit further includes, repeating at least once, identifying a further set of candidate classes according to the determined association of the unit with classes, searching for presence of the key phrases associated with said further classes, and determining an association of the unit with said classes according to determined presence of the key phrases.

For each of the units of content, the audio component is processed to a preprocessed form suitable for searching for presence of key phrases, and the preprocessed form of the audio is stored in association with the unit of content.

Processing the audio components to the preprocessed forms includes forming phonetically-based representations of the audio components.

Subsequent searching for key phrases in the audio component includes searching the preprocessed form for the key phrases.

Storing the preprocessed form includes forming an integrated data representation of the unit of content that includes the audio component and the preprocessed form of the audio component.

Storing the preprocessed form includes storing the preprocessed form at an address determined according to an address of the unit of content.

The preprocessed form is provided in conjunction with the unit of content.

An integrated transport stream with the preprocessed form and the unit of content is provided.

Access to the multimedia content is provided. This access includes accepting a query for content, and determining units of content matching the query according to the meta data for the units.

Determining units matching the query includes searching the audio components according to query terms not represented in the meta data for the units.

The meta data for units is augmented according to the searching of the query terms.

The query is accepted from a user computer, and searching the audio components includes distributing preprocessed forms of the audio components to the user computer, and receiving results of searching for the query terms from the user computers.

In another aspect, in general, a computer-implemented method is directed to searching a multimedia source. A query is received. Presence of the query is detected in a meta data associated with the multimedia source, the metadata including a respective description of each of one or more segments of the multimedia source. Based on the detection result, a segment of the multimedia content that corresponds to the query is located.

Aspects may include one or more of the following.

The metadata includes a product of processing audio of the multimedia source.

Detecting the presence of the query includes applying a phonetically based word spotting procedure to locate the query in the metadata.

The query includes a text query.

The detecting of the presence of the query in the metadata includes processing the text query to identify whether one or more components of the text query are represented in the metadata associated with the multimedia source.

The query includes an audio query.

The audio query is processed into a text query and the text query is processed to identify whether one or more components of the text query is represented in the metadata associated with the multimedia source.

The multimedia source is represented in a file format that enables the metadata to be embedded within the multimedia source.

The respective description of each segment of the multimedia source includes a time location of the segment, or a link from a portion of the metadata that contains the respective description to the corresponding segment of the multimedia source.

In another aspect, in general, a computer-implemented method is directed to tagging a multimedia source. A query is received from a first user. Presence of the query is detected in a text source associated with the multimedia source. Based on a result of the detection, a segment of the multimedia source that corresponds to the query is located. A tag associating the query to a time location of the segment of the multimedia source is created. The tag is accessible to a second and subsequent user.

Aspects may include one or more of the following.

The tag is distributed to the second user through a centralized server.

The tag is distributed to the second user in a peer-to-peer fashion.

An index of the multimedia source is generated, and the index is updated based on the newly-created tag.

A representation of the tag is stored within the multimedia source.

In another aspect, in general, a computer-implemented method is directed to validating a user-supplied annotation for a multimedia source. Components of the user-supplied annotation are identified. A text source associated with the multimedia source is accessed. Whether the text source contains a representation of one or more of the identified components of the user-supplied annotation is detected. Based on a result of the detection, a tag associating the user-supplied annotation to the multimedia source is created.

Aspects may include one or more of the following.

The multimedia source includes a set of segments that have been pre-processed to align with corresponding portions of the text source.

The tag is configured to link the user-supplied annotation to a segment of the multimedia source that is aligned to the portion of the text source that contains the representation of the one or more of the indentified components of the user-supplied annotation.

The text source includes at least one of the following: a text news article that is related to the multimedia source, a web page that includes or links to the multimedia source, producer notes that are used to prepare the multimedia source, a transcript aligned to the multimedia source, optical character recognition (OCR) of text in the multimedia source, meta tags, keywords, an abstract or a summary provided by an author or editor of the multimedia source, and closed captioning of the multimedia source in the form of a TV broadcast.

In another aspect, in general, a computer-implemented method is directed to presenting advertisements to users of a multimedia source. One or more search terms associated with the multimedia source are identified. A mapping that associates a set of search terms with a plurality of advertisements is accessed. Based on the identified search terms and the mapping, an advertisement is selected to be presented to users of the multimedia source.

The search term includes at least one of a key word or a phrase present in a metadata of the multimedia source, and a key word or a phrase present in an audio portion of the multimedia source.

The selection of the advertisement is conditioned on a score computed using the identified search terms.

The search term includes a topic term.

The mapping includes a predefined topic tree being aligned to the plurality of advertisements, the topic tree having a number of nodes each representing a classification of topic terms.

A presentation of the selected advertisement is synchronized with a presentation of the multimedia source.

Other features and advantages of the invention are apparent from the following description, and from the claims.

### DESCRIPTION OF DRAWINGS

FIG. 1 is a block diagram of a system for accessing multimedia content.

FIG. 2 is a screenshot of a media player with a plug-in search tool.

FIG. 3 is a flow chart of a procedure of the plug-in search tool shown in FIG. 2.

FIG. 4 is a flow chart of a procedure of collaborative tagging.

FIG. 5 is a flow chart of a procedure of tag validation.

FIG. 6 is an illustration of one embodiment of advertising synchronization.

FIG. 7 is an illustration of another embodiment of advertizing synchronization.

### DESCRIPTION

### 1 Multimedia Access System Overview

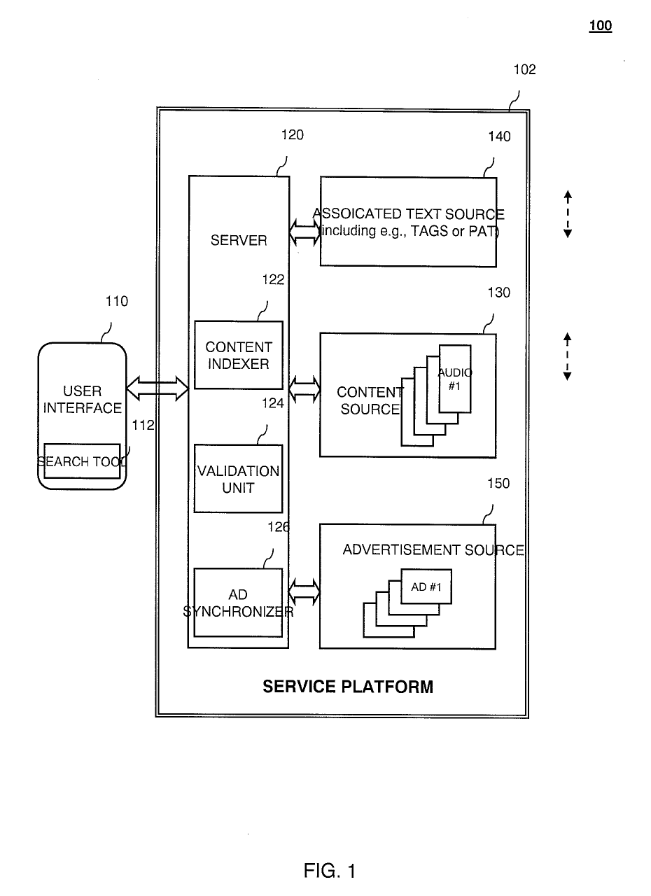

Referring to FIG. 1, a system 100 includes a user interface 110 through which a user can access portions of a content source 130 stored on a service platform 102. Here, the term “platform” is used to refer to a collection of components, which may, for example, be hosted on a single computer, or distributed over multiple computers. For example, the components may be distributed on a number of web servers on the Internet, and the content source 130 may include many separately administered sources of content. Various forms of data used in the system may be distributed among various components, for example, with media, domain ontologies, keyword lists, etc. described in this specification being distributed among the components.

In general, the content source 130 includes a library of multimedia content provided in various forms, including, for example, audio content, video content and animation content. Note that the term “library” is used loosely here, without necessarily connoting a particular arrangement of the content on one or more computers or particular interfaces or ways of accessing the content. A unit of content in the library may include multiple segments that are not explicitly demarcated. For example, a unit of video content for an evening news program may include multiple stories without intervening scene changes or commercial breaks. Alternatively, a unit of content may have been pre-processed to be integrated with or linked with an associated text source 140, which provides, for example, author-supplied metadata (e.g., tags) or other text-based descriptive information in association with the content or with individual segments of the content. For example, the evening news program may have been processed into multiple segments that is each annotated by a specific tag (e.g., “world news” and “domestic news”), thereby allowing a user to select a particular segment without having to scanning through the program. For the purpose of brevity, methods and techniques in this specification will be illustrated primarily with reference to audio content, although various implementations of these methods and techniques are also applicable to other forms of multimedia content.

In providing users with various forms of access to the content source 130 and other sources on the service platform 102, the server 120 incorporates several modules that perform a wide range of functionalities. These modules include one or more of a content indexer 122, a validation unit 124, and an advertizing synchronizer 126, each described in detail later in this document.

Generally, users are provided with access to content based on retrieval requests provided by the users. One type of retrieval request is the specification of a query that is provided to the service platform, and according to which the service platform provides access to one or more units of the content. In some text-based content retrieval systems, a user specifies a query as a set of keywords that the user wants to find in a unit of text content, and text documents are found satisfying the query based on preconstructed indexes that represent the presence of various keywords in the units of text content. In some examples, the user queries for audio-based multimedia content are similar to the queries that would be made for text content, and can include sets of keywords, more complex Boolean queries, for example, using AND, OR, ANDNOT, etc. operators, and can make use other operators, such as proximity based operators (e.g., word 1 within 5 seconds of word 2).

In the case of multimedia content that is handled by the service platform 102, the system makes use of one or more techniques to satisfy user queries. These include one or more of the following, which are described in further detail below:
Pre-processing the audio components of units of multimedia content to a form that permits later searching for particular keywords (or more generally, search queries), for example, at the time a user specifies a query, and saving the processed form in association with the multimedia content.
Processing of audio components of multimedia content (e.g., using the stored pre-processed audio) prior to processing the audio for particular search queries from uses to identify the presence of keywords (where, in general, it should be understood that references to use of “keywords” apply equally to key phrases of one or more words, which may take the form of complex Boolean queries) that may characterize the audio content.
Classifying the content according to predefined groups, such as according to predefined topics or automatically determined clusters.
Processing the audio components of (e.g., using the pre-processed audio) at the time of receiving a query from a user.
Storing keywords that are detected in audio as part of processing user queries.
Matching user queries to previously detected keywords (e.g., based on the processing prior to accepting queries, or based on prior user queries).

To access the content source 130, the user interface 110 communicates on behalf of users (e.g., user accessing the user interface via client computers) with a server 120 to locate and retrieve content of interest. In general, a user provides a query via the user interface 110, which is passed to the server 120, which identifies content that matches the query, for example, based on already identified keywords present in audio content, or on audio searches conducted by the server in response to the received query. In some examples, the user interface 110 includes a plug-in search tool 112 (e.g., an audio search tool), which allows client computers to locally execute audio searches (e.g., queries in text or by voice), for example, in original audio content or in pre-processed audio that was previously formed by the server or other entities. For example, a PAT (Phonetic Audio Track) file associated with a unit of audio content may be stored at a location based on the URL of the audio or in the same binary file of the audio. In some examples, the search tool 112 then enables a user to navigate the audio of content identified by the server 120 and/or using locally executed searches.

### 2 Pre-Processing Audio

As introduced above, in some examples, audio content may be searched multiple times to locate particular keywords. For example, when a unit of audio content is first added to the system, it may be processed to determine the presence of a set of predetermined keywords. That same audio content may later be processed to determine the presence of keywords not originally searched for, for example, based on a particular user query, or based on a modification of a standard set of keywords that is maintained by the system.

In one example of such pre-processing, the server 120 creates and maintains a separate library (e.g., on one or more Web servers) of audio processed as PAT (Processed Audio Track) files. An example of a form of PAT file is described in U.S. Pat. No. 7,263,484, titled “Phonetic Searching,” which is incorporated herein by reference. In some examples, such PAT files are created elsewhere, for example, by entities that provide the content source for the system. In ether case, the user interface 110 and/or the server 120 have access to the PAT files, for example, according to a transformation of a URL for a unit of content to yield a URL for accessing the PAT file.

In some examples, the system makes use of an explicit ingestion process by which units of content are added to the system (e.g., “uploaded”) using the explicit procedure. In some such examples, the pre-processing of associated audio may be performed at the time in ingestion. In some examples, the server automatically locates new content (e.g., “crawls” a network, such as the Internet) to indentify new units of content to add to the library, and in such examples, the pre-processing may be performed when the new content is located in a crawl.

### 3 Keyword Detection in New Content

Audio content that is added to the system, for example, that is added based on an explicit ingress procedure or based on network crawling, is in some examples initially processed to identify a predefined set of keywords that may be present in the content. Such keywords are effectively added to the metadata associated with the content, which may be used later by the server to process queries issued by users.

One process for identifying such keywords is for the system to maintain a common list of keywords that is used to search all new items of content. For example, such a list may have hundreds, thousands, or tens of thousands of entries. In some examples, the system may modify the common list, for example, because a new term may become important. For example, a proper name of an individual, who was previously unknown, may become significant for satisfying user queries, and therefore may be added to the common list. If a pre-processed audio file for the content is kept by the system, adding a new keyword to the common list requires only searching for that keyword rather than having to redo the processing of the keywords that remain for the previous version of the common list. An approach to such searching is described in U.S. Pat. No. 7,263,484, titled “Phonetic Searching.” In some embodiments, searching for keywords make use of a technique in which possible or likely false alarm phrases are identified for keywords that are being validated, for example, as described in copending application Ser. No. 12/391,395, titled “Word Spotting False Alarm Phrases,” filed Feb. 24, 2009, which is incorporated herein by reference.

In some systems, the size of a common list of keywords would have to be substantial in size to cover a reasonable fraction of terms used in user queries. As an alternative to having a single common set of keywords, a multiple stage approach to searching for keywords is used.

Referring to FIG. 8, in one example of a multiple stage approach a separate set of keywords 804 is associated with each of multiple states 802. The states 802 may be elements of a prespecified ontology or taxonomy or other representation of linked elements. In FIG. 8 the states are identified as a set of links states, with state SI being specified as a starting state. One approach to searching for keywords to start with one, or a relatively limited number of states, and search for keywords in the set of keywords associated with those states. As an example, in an application for locating keywords for audio news content, the initial states may correspond to broad categories of news stories (e.g., “world news”, “business”, “sports”, “weather”, etc.). In general, some of the states may better match the audio content than others based on their keyword content. Effectively, the degree of match may be considered as a topic identification based on the keyword content, and various approaches to quantification of the degree of certainty that a unit of content corresponds to each of the possible states may be used, for example, weighing each keyword according to its information bearing content (i.e., with some keywords providing more discrimination power than others). A subset of the states (e.g., the best one or N states, those states with match scores above a threshold, etc.) is pursued in further stages. Neighboring states to those states are then identified based on the representation of the relationships among states. As an example, suppose that the initial state S1 for “sports” state has a high degree of match to keywords KWD-1 that are generally related to sports based on a stage 1 keyword detection (block 810) based on those keywords. The neighboring states (i.e., states S2 and S3) to sports may include states specific to particular sports, such as “hockey” (S2), “baseball” (S3), etc. The set of keywords associated with each state is then searched (e.g., KWD-2 and KWD-2 at the stage 2 keyword detection block 810) to identify further keywords. In some implementations, the process is repeated in a “breadth first” manner maintaining a list of active states at each stage. In some implementations, a “depth first” approach is used, essentially pursuing the best matching state until there are no more neighbors or the degree of match reaches an end condition, for example, because none of the sets of keywords for neighboring states match sufficiently. Other implementations that explore multiple states of such a linked set of states may also be used.

Note that the result of the stages search for keywords is a relatively robust way of obtaining keyword metadata for a unit of audio content. For example, the keywords for the Baseball state S3 match the audio well, and if a state (S5) related to the Boston Red Sox baseball team may be reached from “sports” (S1) to “baseball” (S3) to “Boston Red Sox” (S3), the detections of keywords that correspond to players' names or nicknames (i.e., in keyword set KWD-5) have a relatively high likelihood of being correct, as compared to a detection of those same names in a general set of audio content. That is, for the same detection rate, this approach may yield a significantly lower false alarm rate, and therefore provide a more precise set of keywords in the metadata for the audio content.

In some examples, the ontology or taxonomy is based on manual specification, for example, based on human knowledge of the domain of the content. In other examples, the states are determined in an automated manner, for example, from a corpus of text material (e.g., text news articles or transcriptions of news broadcasts). In other examples, other representation of a domain of knowledge can be used, for example, representations in which a set of topics are interrelated, and there is at least some source of possible keywords for each topic, for example, based on text material associated with that topic. For example, an online text dictionary, such as Wikipedia, may server as a basis for the specification of the related states, and the content of the dictionary entries used to specify the keywords to search for. In some examples, more structured databases, taxonomies, or ontologies may be used, for example, as are currently available from the Dbpedia community project, the Freebase collaborative knowledge base, or the Cyc artificial intelligence project.

Note that as in the case of a single list of common words, as the set of keywords associated with a state with which a unit of content has been associated in the multistage process is changed, the added keywords may be searched for to augment the metadata for the unit of content. For example, if a player is added to roster of the Boston Red Sox, if a unit of content has previously been associated with the a state corresponding to the Boston Red Sox, that content would be searched to see if the added keyword (i.e., player name) is present, and if so, that keyword would be added to the metadata for that content.

In some examples, other approaches are used to determine an association of content with a group, such as a topic based group, and keywords associate with that group are searched for. The multistage process described above can be considered as one way of classifying the content into one or more groups. Other ways of determining such associations may be according to the source of the content, and processing of the multimedia or associated text content. For example, text-based topic classification on text associated with a unit of multimedia content may be used to classify the content, and thereby determine an appropriate set of keywords to search for.

In some examples, the content indexer 122 generates a dynamic index for retrieval of specific units of the content source 130 as well as segments within each piece.

In some examples, in addition to recording the presence of particular keywords, along with their time(s) of occurrence and confidence score(s) in a unit of content, the system also keeps information of what keywords where not found in the content. For example, the keyword lists applied to the content, or explicit lists of keywords with no hits are associated with the content.

### 4 Keyword Validation

In some examples, units of multimedia content are tentatively associated with keywords, and the system validates whether those keywords are truly present in the audio of the content. For example, the validation unit 124 verifies, for example, during ingress of an audio uploaded by a user through interface 110. In some examples, the author can provide text-based information characterizing the content for example in the form of a descriptive passage, keywords (e.g., meta tags), or links to related content. The validation unit 124 verifies that author-supplied information, such as tags or links, truly correspond to the contents of the audio. For example, the validation unit 124 can use a phonetically based word-spotting approach to locate terms (e.g., “Olympic”) in an audio file being annotated by its author as “2008 Olympic Games” to verify the correctness of this annotation. Validated tags can later be incorporated into the dynamic index to facilitate access to the newly uploaded or processed multimedia.

In some examples, the tentative keywords are not explicitly provided by a user. Rather, they are determined in an automated manner by the system. One example of such automated processing involves first automatically identifying text material associated with the multimedia content (e.g., based on forward or reverse hyperlinks, index information, file structures, naming conventions, etc.), and then extracting tentative keywords from that content. One approach to selecting the tentative keywords is to apply a linguistic analysis that identifies entity names within the text. Examples of entity names are the names of people, places, or companies. In some examples, a larger set of tentative keywords is determined, for example, selecting all relatively uncommon words in the text, all nouns or noun phrases, or using other statistical, linguistic, and/or heuristic techniques.

In some examples, keywords that are not validated (i.e., not actually found in the audio) are recorded as being absent from the audio.

### 5 Plug-In Search Tool

In general, at the time that a user provides a query for content to the system, audio content of all, or at least a substantial fraction, of the library has been pre-processed allowing relatively rapid searching based on user-specified queries. In addition, some or all of the content includes keyword metadata that is determined by the system prior to receiving the user's query, for example, using various techniques described above.

In one approach to processing a user's query, the metadata associated with content is used to identify a content that may satisfy the user's query. For example, if the user's query requires the presence of a particular keyword, say “Boston”, then the metadata may be used to select units of content that have already been identified as having that keyword present in their audio, and similarly, metadata may be used for reject content in which that keyword was searched for but not found. In addition, a set of content in which the keyword has not been previously searched for is identified as requiring audio searching.

In some examples, statistical and/or semantic relationships between a user's query and the metadata are used to identify content that may satisfy the user's query. For example, a query for “capital of Massachusetts” may be automatically semantically linked with the keyword “Boston” which is found to have been detected in certain units of content.

In some implementations, the system includes a centralized search function, which is used to search for keywords that were not previously considered in a unit of content.

In some implementations, the search tool 112 provides a customized application programming interface (API) in an audio or audio-video player that allows incorporation of search-related functionality, such as searching for instances of words, phrases, or more complex search terms. For example, the search system may provide the search tool with an identification of content that may satisfy the user's query based on previously considered keywords, for example, with associated scores based on the confidence of the presence of those keywords. The search tool then further processes those units of content to complete the search for keywords that were not previously considered.

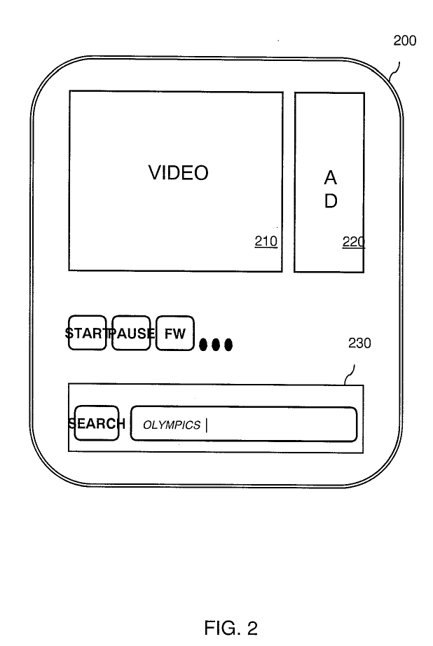

Referring to FIG. 2, a representative screen shot of a media player 200 with a built-in search module is shown. The media player 200 includes a video window 210 that displays streaming media content, an advertizing window 220 that displays ads along with the media content, and a search tool 230 that enables users to navigate a web-based content archives By entering one or more key terms (e.g., “Olympics”), users can search in the associate text source 140 (e.g., content tags, associated PAT files, or other text-based sources from which tags or PAT files may be derived) to locate segments that correspond to the key terms. The content tags and the associated PAT files can be embedded in or associated with the content. The list of search results can be shown, for example, in the video window 210 or in a separate pull-down window, as URLs ready for user selection.

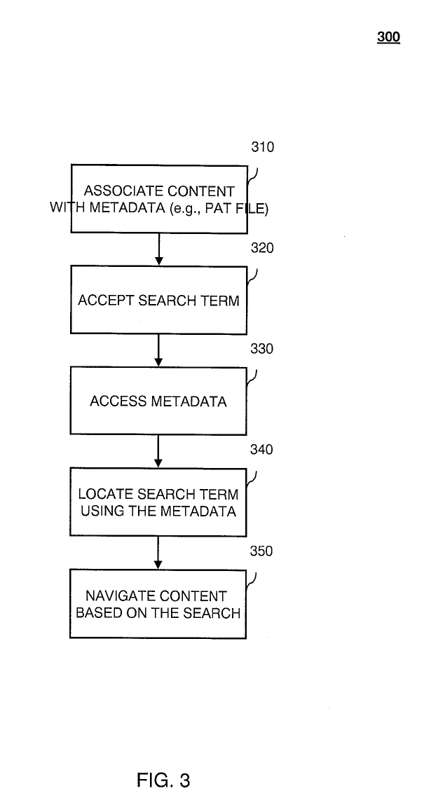

Referring to FIG. 3, a flow chart 300 illustrates an exemplary search procedure implemented in the search tool 230. First, in step 310, metadata (e.g., a PAT file) is generated in advance by the server 120 or other system components in association with a unit of content.

One example of associating a PAT file (or similar information) with the content is to embed the PAT file with the content using extensible characteristics in a standard content file. For example, some file formats, e.g., Adobe Acrobat, may allow metadata to be stored within the file. The PAT file data can thus be stored within a content file using such a capability. In other examples, the PAT file is associated with the content using a naming convention, for example, such that a URL of a unit of content may be processed to automatically generate a URL of the associated PAT file. In another example, the PAT file (or similar information) is bundled together with the media for streaming (i.e., either stored together, or composed at streaming time) as a unit, for example, multiplexing the PAT data in a transport stream format with audio and video data (e.g., in an MPEG transport stream format).

In steps 320 and 330, the search tool 230 accepts search terms from a user and accesses the PAT file to locate the search terms. The PAT file may include, for example, text-based headings derived from associated text sources (e.g., a transcript of the audio) and hyperlinked to the associated segments that were previously identified in the audio. Subsequently, in steps 340 and 350, the search tool 230 finds the search terms and then navigate the content (e.g., cue to term locations) based on the result of searching.

In some examples, the underlying content file format is modified to allow metadata to be stored in the same binary file as the audio contents. In some other examples, file modification is not necessary. For example, if for each content URL, a second content URL can be defined by rule (e.g., by appending a string, or other text transformation), then the search tool 230 can be configured to access the associated PAT file when the user specifies the base URL.

To provide uses with the search tool 112, in some examples, custom player software applications with search functions are distributed to users. In some other examples, software plug-ins to standard media players may be distributed.

### 6 Collaborative Processing

In some examples, when a user specifies a query that requires determining the presence of keywords not previously considered for some or all of the content, and the centralized or distributed search for those keywords is conducted, the detection of those keywords, and the determination of their absence, is recorded with the metadata for the content. This new metadata is then available for resolving further queries received by the system without requiring repeated searching of the audio.

In some examples, the search results are thereby distributed to other users through a centralized server. In some implementations, metadata related to the presence or absence of particular keywords in content is maintained in a distributed database form in a peer-to-peer architecture. In the peer-to-peer approach, a “viral” tagging (e.g., distributed annotation) of content is possible with a distributed directory of terms located in existing content.

A second implementation of the plug-in search tool provides an authoring/tagging tool that allows users to collaboratively identify segments within longer content. For example, if a player with a customized plug-in allows a user to identify a “clip” within the larger content, for example, a particular skit in a comedy routine, the segmentation can also be communicated to a central server or otherwise made available to other users. Further searches by other users can then find the smaller clip as well as the longer content. For example, users may find particular parts of a comedy routine.

In some examples, the authoring tool is configured to be able to add a PAT file (or similar information) into content. In some examples, the authoring tool is also provided to augment content files, or to manage related file repositories.

As introduced above, collaborative tagging can provide an efficient indexing mechanism that takes advantage of users' activities (e.g., searching and accessing of content) to facilitate rapid retrieval of specific media content by subsequent users.

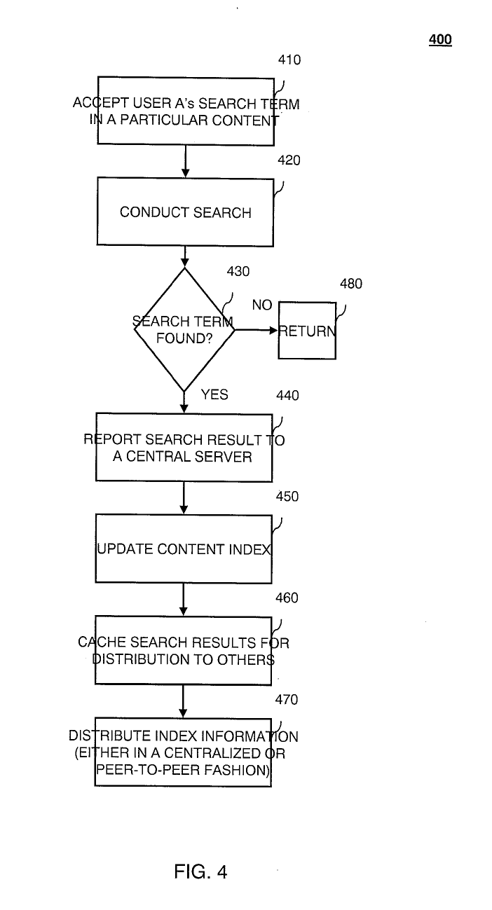

Referring to FIG. 4, a flow chart 400 illustrates an exemplary procedure of collaborative tagging. In step 410, a user's search term on a particular piece of audio is accepted. In step 420, the search tool 112 conducts a query in the PAT file or other associated texts or metadata of the audio to locate relevant segments. If the query is successful, the presence of the search term in conjunction with the time location of the segment within the audio can be reported to a central site, in step 440. In some examples, the confidence score of the relative accuracy of each “hit” may also be reported for future use.

Next, in step 450, the content indexer 122 uses the search result to index the content, for example, by editing the PAT file and creating a new tag for each query. The content indexer 122 also caches the search results for distribution to others, in step 160. Later, in step 470, when other users are streaming the content and performing searches, in addition to sending a PAT file to the users, the indexer 122 may also send the previously-located terms along with the content. In this way, if a new user asks to locate terms that have been searched for, the results are already known and the repetition of the search procedure can be avoided. Note that the distribution of the index information can be centralized, or distributed in a peer-to-peer architecture.

Using collaborative tagging, a database of tags can be built dynamically for a set of content, without having to know in advance what terms will be used. This also provides a means for users to rapidly locate content of interest through incremental searches. For example, if an evening news broadcast has been previously tagged by a first user as having a “world news” segment and a “domestic news” segment, a subsequent user looking for “July 4th fireworks” can specifically search within the “domestic-news” segment, without having to navigate through the possibly irrelevant “world-news” segment. The knowledge of the terms present in the audio can also be used to better match advertising to audio content based on the previous detections triggered by the searches of prior users, as will be described later.

### 7 Tag Validation

Examples of the system may include additional aspects of tag validation and discover, as described below.

As collaborative tagging allows various users (including authors and viewers) to tag multimedia content at different stages (e.g., during creation, ingestion, or access of content), sometimes, erroneous or misleading tags may be created. For example, a supplier of a video clip of “The Tonight Show with Jay Leno” may have accidentally annotated it as “The Tonight Show with David Letterman,” or, a supplier may have intentionally mislabeled a song as “Britney Spears” solely to boost popularity. It is thus useful to perform a screening procedure to validate newly-created tags and to only allow relevant ones to be incorporated into the content index.

In some implementations, the validation unit 124 uses associated text sources to restrict the words or phrases that can be entered in the index. Techniques such as large vocabulary recognition or word-spotting can be used as a basis for determining words or phrases that are present in the content and that can be used for indexing. For example, if the name “David Letterman” does not occur in the associated text source (e.g., transcript or closed captioning) of the audio/video, then this tag may be deemed as invalid.

Examples of associated text source include the following:
a text news article that is related to an audio broadcast
a web page that includes or links to an audio
producer notes that are used to prepare a broadcast
a transcript aligned to an audio recording
optical character recognition (OCR) of text (embedded in scenes and/or in textual overlays) on videos
meta tags and keywords, or an abstract or summary, provided by an author or editor of the audio content
search terms used by one or more users in trying to access the content
closed captioning of a TV broadcast
agents call notes entered after a telephone call
related taxonomy or word list, automate tagging approach, distribute with media file with or without PAT file data

In some examples, word-spotting may be restricted to terms that are related to the associated text. The restriction may be literal, so that only words that occurred in the text are looked for. In some other examples, less restrictive associations can also be used. For example, a thesaurus can be used to expand the vocabulary of the associated text, and topic classification can be used to introduce vocabulary on the same topic. Some techniques of word-sporting are described in U.S. patent application Ser. No. 12/035,596 (Attorney Docket No. 30004-017001), titled “Accessing Multimedia,” filed Feb. 22, 2008, and in U.S. patent application Ser. No. 11/748,319 (Attorney Docket No. 30004-014001), titled “Wordspotting System,” filed May 14, 2007, the contents of which are incorporated herein by reference.

In some examples, after terms are verified to be present in the content, automatic links are constructed from the associated text to an audio clip so that a reader of the text can also have access to the related audio. Various types of linking can be used, including using the words in the text as links, as well as other forms of annotation that can accompany the original text (e.g., “notes” next to the text).

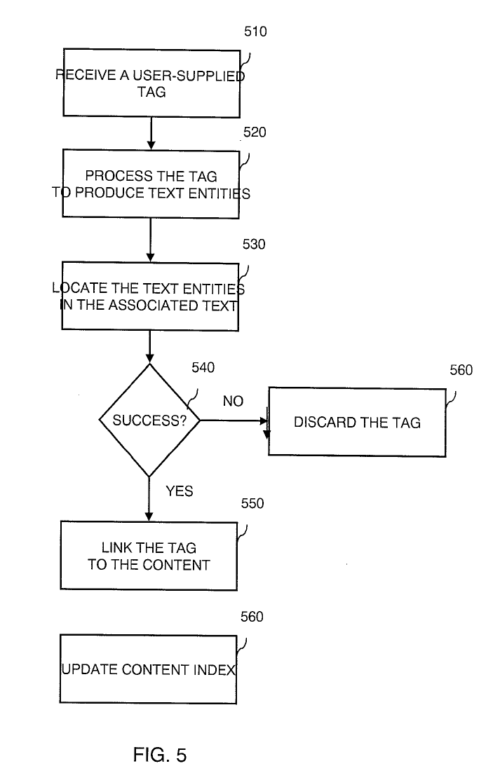

FIG. 5 shows a flow chart 500 that illustrates an exemplary procedure of tag validation described above.

In some examples, it may not be necessary to verify the entire text of a tag against the content. Instead, text processing can be first applied to identify a limited number of entities (e.g., words or word sequences) in the tag, for example, based on syntactic and semantic processing. Then only those entities identified by automated techniques are validated against the associated text source.

One advantage of using associated text for tag validation is that false alarm rate can be greatly reduced, because words in associated text typically have a higher likelihood of occurring in the audio than general words (e.g., a 50000-word vocabulary).

### 8 Advertising Presentation

The system provides a mechanism for presenting multimedia content to users, for example, using a client-based “player” application. As discussed further below, the content presented to the user may be selected according to a search query specified by the user. In some examples, the user may select content in other ways, for example, based on a hyperlink browsing approach, or the content may be selected for the user, for example, based on a model of the user's preferences.

In any case, examples of the system provide a way to present advertising during the playing for content to the user. In some examples, the advertising synchronizer 126 makes use of the metadata that identifies which keywords are present in the content, and their time locations within the content, to present advertisements that are both synchronized with the content and targeted to the user based on specific keywords or phrases. For example, the service platform 120 may host an advertisement source 150 that includes a library of ads of various forms and topics that is mapped to keywords, terms, or topics. When a user is viewing a video segment tagged as “2008 Olympic Games,” the advertizing synchronizer 126 may identify an association between “Olympic” and “sports” and therefore present users with ads under the “sports” topic (e.g., Nike ads) in the time proximity of the audio occurrence of the words “Olympic Games.”

In some examples, further features of the content are used to determine when and/or where in an image the advertising is presented. For example, video processing may be used to determine scene changes, or audio events (e.g., speaker changes) can be used to select locations at which to insert advertising.

Advertising may be presented in a variety of ways, for instance, as banner or frames surrounding the multimedia content, as overlays (e.g., text crawls) on video content, as overlaid audio, or as time segments of content interspersed in the presentation of the content.

The knowledge of the terms present in the audio, and the time locations of those terms, can be used to better match advertising to audio content, for example, based on author-supplied metadata or the previous detections triggered by the searches of prior users.

One implementation of the ad synchronizer 126 identifies keywords and phrases (or more generally, search terms including Boolean terms) in the audio portion of uploaded content as it is ingested by a system, and uses such information to generate a many-to-many mapping between content and ads based on detected keywords.

One approach to selecting the search terms to look for is to use a large list that is generic to content. When content is played, the appropriate ads are selected according to the mapping. If new words (e.g., new search terms created by viewers) are added to the mapping, only the new words need to be detected in the audio of content to augment the mapping, which requires less computation as compared with full re-recognition of the audio for existing content.

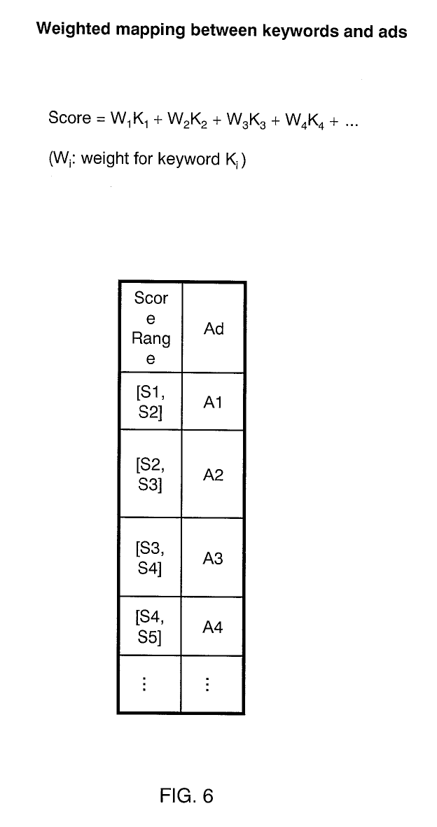

Referring to FIG. 6, an exemplary method of ad selection uses a mapping between content and ads. In some implementations, a mapping score S is assigned to each unit of content or a user-initiated search, for example, based on the keywords associated with the content, the search terms entered by the user, the weight of each keyword, and possibly the confidence score of each detection of search terms. The ads to be presented to viewers in association with the content are thus selected according to the value of S.

Another approach to selecting the search terms addresses false positives (false alarms) in detection of keywords in the audio. This approach uses a predefined taxonomy (tree structure) of topics.

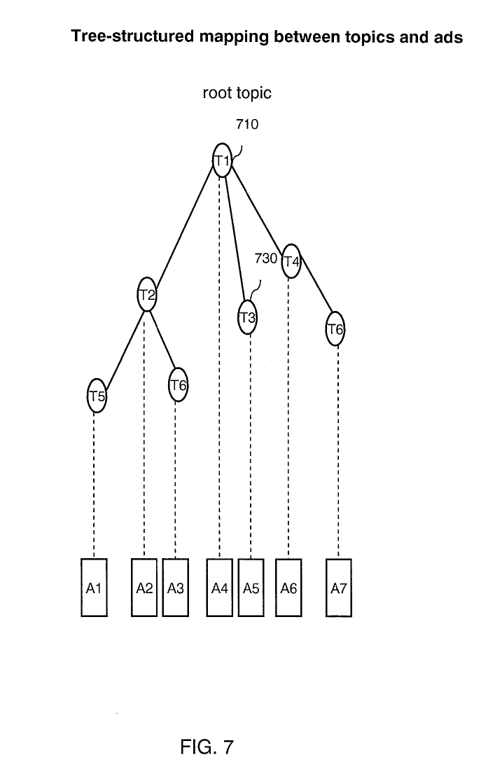

Referring to FIG. 7, the ad synchronizer 126 implements a pre-trained topic classification system that descends through a pre-defined topic tree based on keyword detections in the content. During ingestion of content, the tree is “walked” from a root topic 710 to a leaf topic (e.g., 730), and potentially stops before the leaf if there is insufficient information to go further. The result is a topic classification of the content. Ads are then selected for co-presentation with the content based on a topic-to-ad mapping, which is predetermined and typically many-to-many. One advantage of this approach is that it avoids gross errors, for example, that may result from confusion of similar sounding words (“browser” versus “trouser”). Also, in some applications, advertisers may be able to bid for different levels of the hierarchy in the tree.

Another approach to selecting the search terms uses language classification as well as or instead of topic classification in ad selection. For example, using language identification can limit ads to match the language of the content, or to weigh matching language more highly than other languages.

In addition to selecting the ads to be presented along with content, the ad synchronizer 126 is also configured to synchronize ads with the timeline of the presentation of content. For example, a unit of content may be classified broadly as consumer electronics. Within the timeline of the content, different words or phrases may be detected. One approach involves sequencing ads according to the time locations of the detections. For example, ads may specify rules regarding desired or minimum durations, and proximity to associated words. The ad scheduling process may be chosen to provide fairness among advertisers, and to allow for advertisers to pay for different durations of ads.

Various approaches of synchronization can be combined with detection of words in synchronized text, for example, in closed captioning in a TV broadcast. Using locations of detected words also allows ads to be time locally relevant to the content being presented.

Various approaches of synchronization can be also combined with other verification approaches. For example, words in a text news story can be verified for presence in an audio segment, and then only the present words used for selection of synchronized ads.

In some examples, use of quality of detection can increase goodness of joint scheduling of ads for a unit of content as a whole.

### 9 Other Features and Applications

In some implementations, units of content that are accessible through the system are processed, for example when they are first added or based on a periodic “crawl” of the content, to generate keywords or segmentations. For example, associated production notes or “run down” are used to automate the identification of individual story segment boundaries within a broadcast or long form audio or video content.

In some examples, the search tool provides a dynamic selection of a video key frame(s) based on a search query. The key frame(s) is in time with the spoken word reference in the audio or video, which provides incremental context with each search result.

In some examples, the search tool provides dynamic generation and display of tags related to the search query based on proximity in time.

In some examples, dynamic “playlists” are generated for a user. For example, the playlist may be constructed by the system based on associations of related content based on automation of tag creation.

### 10 Implementations

Embodiments of the approaches described above may be implemented in software, in hardware, or using a combination of software and hardware. For instance, software implementations may include software (e.g., stored on or transmitted over computer readable media) that has instructions for causing a computer processor to perform functions described above. Furthermore, the implementations may be distributed, with various aspects being implemented in different components of a distributed architecture.

As one example, of distributed implementation, the processing of media as it is inputted to the system may be performed in distributed hardware platform that have high-capacity implementations for computing PAT files and in some implementations also performing keyword detection on a set of keywords.

In some examples, the media being processed and made available by the system is obtained by real-time monitoring, for example, of a communication system, such as a telephone system (e.g., at a call center), and the distributed implementation may include components hosted in or linked directly to data (e.g., Voice over IP) or telephone switches.

It is to be understood that the foregoing description is intended to illustrate and not to limit the scope of the invention, which is defined by the scope of the appended claims. Other embodiments are within the scope of the following claims.

What is claimed is:

1. A computer-implemented method for providing access to multimedia content, the method comprising:
accepting audio components associated with a plurality of units of multimedia content, each unit of content including one of the audio components; and
for each unit of the plurality of units of multimedia content, forming meta data associated with said unit, the meta data for the units including an association of key phrases detected in the audio components and the units;
wherein forming the meta data comprises
determining a candidate set of key phrases associated with the unit of multimedia;
searching for presence of the candidate key phrases in the audio components, and
forming data representing the presence of key phrases in the audio components.

2. The method of claim 1 wherein the set of key phrases associated with the unit comprises a universal set of key phrases selected independently of the unit.

3. The method of claim 1 further comprising adding the units of multimedia content to a library of content and wherein the accepting of the audio components of a unit of content is at the time the unit is added to the library, and wherein at least some of the forming of the meta data for the unit is performed at the time the unit is added to the library.

4. The method of claim 1 wherein determining a candidate set of key phrases associated with the unit of multimedia comprises:
accepting the candidate key phrases in conjunction with receiving of the audio component.

5. The method of claim 4 wherein the candidate key phrases are accepted from a party providing the unit of multimedia.

6. The method of claim 1 wherein determining a candidate set of key phrases associated with the unit of multimedia comprises:
identifying text associated with the units of multimedia; and
selecting key phrases according to the identified text.

7. The method of claim 6 wherein identifying the text associated with a unit of the multimedia comprises:
accepting the text in conjunction with receiving of the audio component.

8. The method of claim 7 wherein the text is accepted from a party providing the unit of multimedia.

9. The method of claim 6 wherein identifying the text associated with a unit of the multimedia comprises:
identifying a text component that is linked to the unit of multimedia.

10. The method of claim 9 wherein the text component is linked to the unit of multimedia via a hyperlink.

11. The method of claim 6 wherein identifying the text associated with a unit of the multimedia comprises:
identifying text embedded in a video component of the unit of multimedia.

12. The method of claim 1 wherein determining a candidate set of key phrases associated with the unit of multimedia comprises:
determining one or more classes associated with the unit; and
selecting key phrases associated with the determined one or more classes.

13. The method of claim 11 wherein the classes comprise topics.

14. The method of claim 12 wherein determining the one or more classes associated with the unit is performed at the time that the unit is added to a library, and wherein selecting key phrases associated with the determined classes, searching for the presence of the selected key phrases, and updating the meta data according to the searching is repeated multiple times subsequent to determining the classes.

15. The method of claim 11 wherein determining the one or more classes associated with the unit comprises:
accessing a data representation of a plurality of classes and relationships between the classes;
identifying a first set of candidate classes from the representations;
for each candidate class in the first set, searching for presence of the key phrases associated with said candidate class in the audio component of the unit of content, and determining an association of the unit with said class according to determined presence of the key phrases in the audio component.

16. The method of claim 15 wherein determining the one or more classes associated with the unit further comprises, repeating at least once:
identifying a further set of candidate classes according to the determined association of the unit with classes, searching for presence of the key phrases associated with said further classes, and determining an association of the unit with said classes according to determined presence of the key phrases.

17. The method of claim 1 further comprising, for each of the units of content:
processing the audio components to a preprocessed form suitable for searching for presence of key phrases; and
storing the preprocessed form of the audio in association with the unit of content.

18. The method of claim 17 wherein processing the audio components to the preprocessed form comprises forming phonetically-based representations of the audio components.

19. The method of claim 17 wherein subsequent searching for key phrases in the audio component comprises searching the preprocessed form for the key phrases.

20. The method of claim 17 wherein storing the preprocessed form comprises forming an integrated data representation of the unit of content that includes the audio component and the preprocessed form of the audio component.

21. The method of claim 17 wherein storing the preprocessed form comprises storing the preprocessed form at an address determined according to an address of the unit of content.

22. The method of claim 17 comprising providing the preprocessed form in conjunction with the unit of content.

23. The method of claim 22 comprising providing an integrated transport stream comprising the preprocessed form and the unit of content.

24. The method of claim 1 further comprising:
providing access to the multimedia content, including accepting a query for content, and determining units of content matching the query according to the meta data for the units.

25. The method of claim 24 wherein determining units matching the query includes searching the audio components according to query terms not represented in the meta data for the units.

26. The method of claim 25 further comprising augmenting the meta data for units according to the searching of the query terms.

27. The method of claim 25 wherein the query is accepted from a user computer, and searching the audio components includes distributing preprocessed forms of the audio components to the user computer, and receiving results of searching for the query terms from the user computers.

28. A computer-implemented method for searching a multimedia source, comprising:
receiving a query;
detecting a presence of the query in a meta data associated with the multimedia source, the metadata including a respective description of each of one or more segments of the multimedia source; and
based on the detection result, locating a segment of the multimedia content that corresponds to the query.

29. The computer-implemented method of claim 28, wherein the metadata includes a product of processing audio of the multimedia source.

30. The computer-implemented method of claim 29, wherein detecting the presence of the query includes applying a phonetically based word spotting procedure to locate the query in the metadata.

31. The computer-implemented method of claim 28, wherein the query includes a text query.

32. The computer-implemented method of claim 31, wherein the detecting the presence of the query in the metadata includes:
processing the text query to identify whether one or more components of the text query is represented in the metadata associated with the multimedia source.

33. The computer-implemented method of claim 28, wherein the query includes an audio query.

34. The computer-implemented method of claim 33, further comprising:
translating the audio query into a text query; and
processing the text query to identify whether one or more components of the text query is represented in the metadata associated with the multimedia source.

35. The computer-implemented method of claim 28, wherein the multimedia source is represented in a file format that enables the metadata to be embedded within the multimedia source.

36. The computer-implemented method of claim 28, wherein the respective description of each segment of the multimedia source includes a time location of the segment, or a link from a portion of the metadata that contains the respective description to the corresponding segment of the multimedia source.

37. A computer-implemented method for tagging a multimedia source, comprising:
receiving a query from a first user;
detecting a presence of the query in a text source associated with the multimedia source;
based on a result of the detection, locating a segment of the multimedia source that corresponds to the query; and
creating a tag associating the query to a time location of the segment of the multimedia source, the tag being accessible to a second and subsequent user.

38. The computer-implemented method of claim 37, further comprising:
distributing the tag to the second user through a centralized server.

39. The computer-implemented method of claim 37, further comprising:
distributing the tag to the second user in a peer-to-peer fashion.

40. The computer-implemented method of claim 37, further comprising:
generating an index of the multimedia source; and
updating the index based on the newly-created tag.

41. The computer-implemented method of claim 37, further comprising:
storing a representation of the tag within the multimedia source.

42. A computer-implemented method for validating a user-supplied annotation for a multimedia source, comprising:
identifying components of the user-supplied annotation;
accessing a text source associated with the multimedia source;
detecting whether the text source contains a representation of one or more of the identified components of the user-supplied annotation; and
based on a result of the detection, creating a tag associating the user-supplied annotation to the multimedia source.

43. The computer-implemented method of claim 42, wherein the multimedia source includes a plurality of segments that have been pre-processed to align with corresponding portions of the text source.

44. The computer-implemented method of claim 43, wherein the tag is configured to link the user-supplied annotation to a segment of the multimedia source that is aligned to the portion of the text source that contains the representation of the one or more of the indentified components of the user-supplied annotation.

45. The computer-implemented method of claim 42, wherein the text source includes at least one of the following: a text news article that is related to the multimedia source, a web page that includes or links to the multimedia source, producer notes that are used to prepare the multimedia source, a transcript aligned to the multimedia source, optical character recognition (OCR) of text in the multimedia source, meta tags, keywords, an abstract or a summary provided by an author or editor of the multimedia source, and closed captioning of the multimedia source in the form of a TV broadcast.

46. A computer-implemented method for presenting advertisements to users of a multimedia source, comprising:
identifying one or more search terms associated with the multimedia source;
accessing a mapping that associates a plurality of search terms with a plurality of advertisements,
based on the identified search terms and the mapping, selecting an advertisement to be presented to users of the multimedia source.

47. The computer-implemented method of claim 46, wherein the search term includes at least one of a key word or a phrase present in a metadata of the multimedia source, and a key word or a phrase present in an audio portion of the multimedia source.

48. The computer-implemented method of claim 46, wherein the selection of the advertisement is conditioned on a score computed using the identified search terms.

49. The computer-implemented method of claim 46, wherein the search term includes a topic term.

50. The computer-implemented method of claim 49, wherein the mapping includes a predefined topic tree being aligned to the plurality of advertisements, the topic tree having a plurality of nodes each representing a classification of topic terms.

51. The computer-implemented method of claim 46, further comprising:
synchronizing a presentation of the selected advertisement with a presentation of the multimedia source.
